(19) United States
(12) Patent Application Publication
(10) Pub. No.: US 2005/0113079 A1
(43) Pub. Date: May 26, 2005

(54) SYSTEM AND METHOD FOR TRANSFERRING DATA FILES BETWEEN MOBILE PHONES

(75) Inventor: Hui Guo, Morrisville, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/707,145

(22) Filed: Nov. 24, 2003

(51) Int. Cl. H04M 3/00

(52) U.S. Cl. 455/418

(57) ABSTRACT

A mobile phone having a data software application for exchanging a data file with a second mobile phone. This can be done directly between mobile phones or indirectly using a removable storage medium or remote processing device as an intermediary. To achieve this purpose the mobile phone includes a processor, a processor readable storage medium, and code recorded in the processor readable storage medium to direct activities. The code recorded in the processor readable storage medium includes code to establish a connection with another mobile phone or remote processing device such that data can be exchanged. To send a data there is code to retrieve the data file from internal memory and send the data file via the connection established. To receive a data file to another mobile phone, there is code to receive the data file via the connection established and write the data file to storage in the mobile phone. If a removable storage medium is employed, the data file is copied from the mobile phone to the removable storage medium. Once copied, the removable storage medium can be removed and inserted into another mobile phone where it can be copied into that mobile phone's internal storage.

### BACKGROUND OF INVENTION

Mobile phones today include sophisticated hardware and software designed to enhance the user experience. One of the features commonly included is access to the Internet via a wireless application protocol (WAP) browser. WAP browsers utilize a variety of physical connections to the Internet such as General Packet Radio Service (GPRS), Enhanced Data rates for Global Evolution (EDGE), Cellular Digital Packet Data (CDPD), and Circuit Switched Data (CSD). To make browsing more manageable, bookmarks are utilized to allow quick access to a web-site of particular interest to a user. Bookmarks are simply web addresses that are organized and stored in a bookmark file. When a user accesses her bookmark file, she can select one of interest and the WAP browser will automatically ‘surf’ to that web-site. By using bookmarks, the user is relieved of the task of manually entering the address each time she wishes to go to a new web-site.

Mobile users will add to their bookmark files over time as they find and save web-sites of interest. Often, a user will recommend a web-site to another user. If the other user wishes to access the web-site he will have to manually enter the web-site address because he does not have it bookmarked. The present invention is directed toward removing the need for the second user to manually key in the address of a web-site that has been bookmarked by the first user. This is achieved by executing an application that sends a bookmark file from the first user to the second user. Once the bookmark file is received by the second user, there is no need to manually key-in the address of a web-site.

### SUMMARY OF INVENTION

In one embodiment, the present invention comprises a mobile phone having a data software application for sending and/or receiving a data file to and/or from a second mobile phone. To achieve this purpose the mobile phone includes a processor, a processor readable storage medium, and code recorded in the processor readable storage medium.

The code recorded in the processor readable storage medium includes code to establish a connection with the second mobile phone such that data can be exchanged between the mobile phone and the second mobile phone. Once a connection is established, a data file can either be sent or received. To send a data file to another mobile phone, there is code to retrieve the data file from internal memory and send the data file to the second mobile phone via the connection established. To receive a data file to another mobile phone, there is code to receive the data file sent from the second mobile phone via the connection established and write the data file to storage in the mobile phone.

In another embodiment, the present invention comprises a mobile phone having a data software application for copying a data file to and/or from a removable storage medium that is usable with the mobile phone. To achieve this purpose the mobile phone includes a processor, a processor readable storage medium, and code recorded in the processor readable storage medium.

The code recorded in the processor readable storage medium includes code to retrieve the data file from internal mobile phone storage and write the data file to the removable storage medium when the intent is to transfer a data file from the mobile phone. There is also code retrieve the data file from the removable storage medium and write the data file to internal mobile phone storage when the intent is to receive a data file from another mobile phone that has previously copied the data file to the removable storage medium.

In still another embodiment, the present invention comprises a mobile phone having a data software application for sending and/or receiving a data file to and/or from a remote processing device. To achieve this purpose the mobile phone includes a processor, a processor readable storage medium, and code recorded in the processor readable storage medium.

The code recorded in the processor readable storage medium includes code to establish a connection with the remote processing device such that data can be exchanged between the mobile phone and the remote processing device. Once a connection is established, a data file can either be sent or received. To send a data file to the remote processing device, there is code to retrieve the data file from internal memory and send the data file to the remote processing device via the connection established. To receive a data file to remote processing device, there is code to receive the data file sent from the remote processing device via the connection established and write the data file to storage in the mobile phone.

### BRIEF DESCRIPTION OF DRAWINGS

FIG. 1 is a block diagram illustrating functions within a mobile phone used to carry out a direct transfer of a data file between two mobile phones.

FIG. 2 is a flowchart describing a direct transfer of a data file between two mobile phones.

FIG. 3 is a block diagram illustrating functions within a mobile phone used to carry out an indirect transfer of a data file between two mobile phones using a removable storage medium operable with both mobile phones.

FIG. 4 is a flowchart describing an indirect transfer of a data file between two mobile phones using a removable storage medium operable with both mobile phones.

FIG. 5 is a block diagram illustrating functions within a mobile phone used to carry out an indirect transfer of a data file between two mobile phones using a personal computer (PC) as an intermediary.

FIG. 6 is a flowchart describing an indirect transfer of a data file between two mobile phones using a personal computer (PC) as an intermediary.

### DETAILED DESCRIPTION

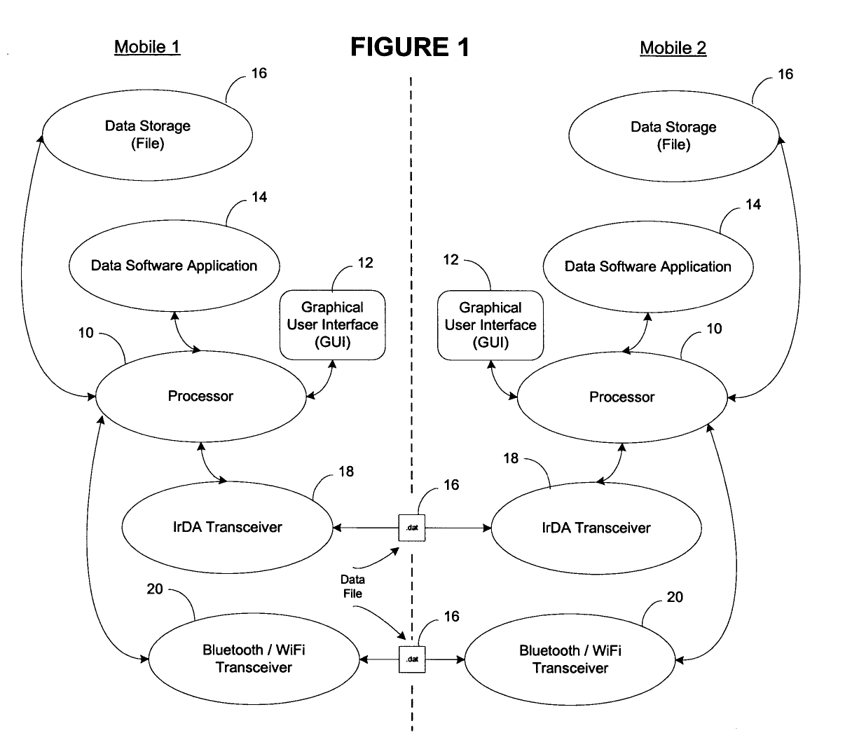

FIG. 1 is a block diagram illustrating functions within a mobile phone used to carry out a direct transfer of a data file between two mobile phones. FIG. 1 illustrates two mobile phones wirelessly communicable with one another. Central to each mobile phone is a processor 10 that has control over and access to the other components within the mobile phone that comprise the invention. A graphical user interface (GUI) 12 provides an interface with the user of the mobile phone to navigate and launch a data software application 14, the purpose of which is to facilitate sending a data file 16 from one mobile phone to another mobile phone. GUI 12 displays status information and prompts for input(s) at the behest of the data software application 14 running on processor 10. The transfer mechanism between phones is a wireless transmission protocol such as an infrared (IrDA) transceiver 18 or a low power RF transceiver such as those associated with the Bluetooth™ or a WiFi protocol 20. The transfer mechanism is not intended to be limited to either IrDA 18, Bluetooth™ or WiFi 20 means. As mobile phones further evolve, additional wireless protocols may be included in the phones that can serve as the transfer mechanism.

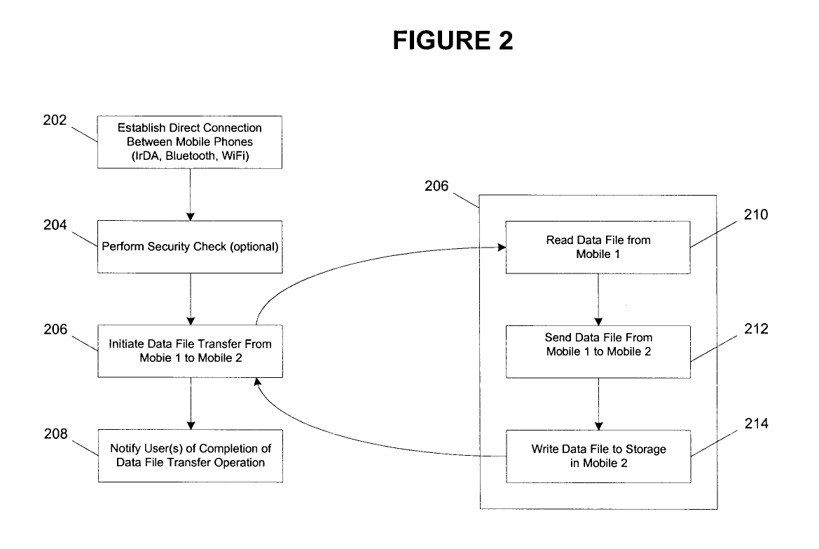

FIG. 2 is a flowchart describing a direct transfer of a data file between two mobile phones. When a user of a first mobile phone (sending mobile phone) wishes to transfer a data file to a second mobile phone (receiving mobile phone), the first step is to establish a direct connection 202 between the mobile phones using a wireless transceiver such as the IrDA transceiver 18, Bluetooth™ or WiFi transceiver 20 described above. Once a connection has been established, an optional security check 204 can be made to ensure the integrity of the process. The next step is to initiate a data file transfer operation 206 from the sending mobile phone to the receiving mobile phone. Once the data file has been sent, each mobile phone notifies its respective user that the operation has completed 208.

The data file transfer operation 206 entails reading the desired data file from memory 210 on the sending mobile phone. The data software application 14 is run causing the processor 10 to prompt the user via GUI 12 to input or select which data file 16 to send. This selection is then read from storage and prepared to be sent over the wireless transceiver mechanism. Since a direct connection has already been established, the data file transfer commences 212 and continues until the entire file has been received by the receiving mobile phone. The receiving mobile phone is also executing its copy of the data software application 14 and recognizes the incoming data file as a data file. Its processor 10 causes GUI 12 to prompt the user to accept the data file 16 and write it 214 to storage in the receiving mobile phone. Once the file is written to storage 214, the process is completed and each user is notified 208 by their respective mobile phones.

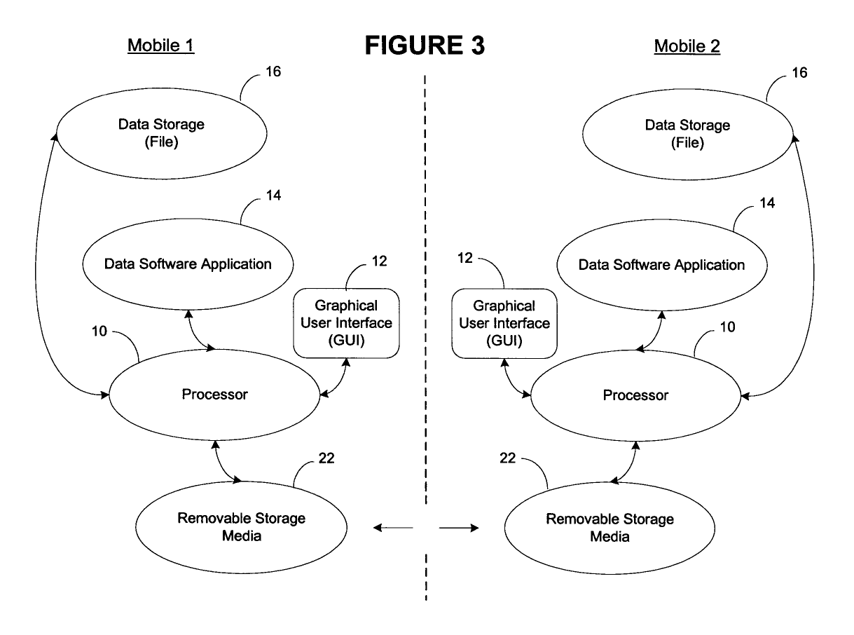

FIG. 3 is a block diagram illustrating functions within a mobile phone used to carry out an indirect transfer of a data file between two mobile phones using a removable storage medium operable with both mobile phones. The description of FIG. 3 is identical to that of FIG. 1 for elements that match. In FIG. 3, however, the wireless transceiver mechanisms are not shown and a removable storage media 22 has been included. The removable storage media 22 is typically a SIM card but can be any storage media capable of being removed from a mobile phone. Some examples include, but are not limited to, a memory stick like that developed by Sony Corporation, or a compact flash card. Future mobile phones may include multiple types of removable storage media. It is the intent of this disclosure to include such developments.

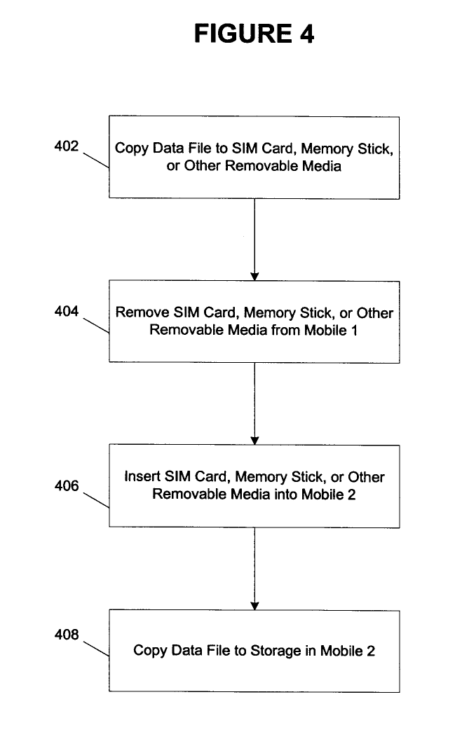

FIG. 4 is a flowchart describing an indirect transfer of a data file between two mobile phones using a removable storage medium operable with both mobile phones. This process entails copying a user selected data file from internal mobile phone memory or storage to a removable storage medium 22. The processor 10 running the data software application 14 solicits user input via GUI 12. The user navigates through the options presented by GUI 12 and selects a data file to copy. Once the file is copied 402 to the removable storage media 22, the removable storage media 22 is uncoupled from the mobile phone 404. It can then be inserted into another mobile phone 406. The second mobile phone also includes a copy of the data software application 14. The data software application 14 can be running in the background so as to recognize a data file 16 when the removable storage media 22 is inserted and automatically prompt the user to take an action. Or, the user can manually initiate the data software application 14 and then operate on the removable storage media 22 accordingly. To complete the process the user selects a write option that causes the processor 10 to write the data file 16 resident on the removable storage media 22 to internal memory 408. Once written, the data file becomes available to the mobile phone's browser applications for use.

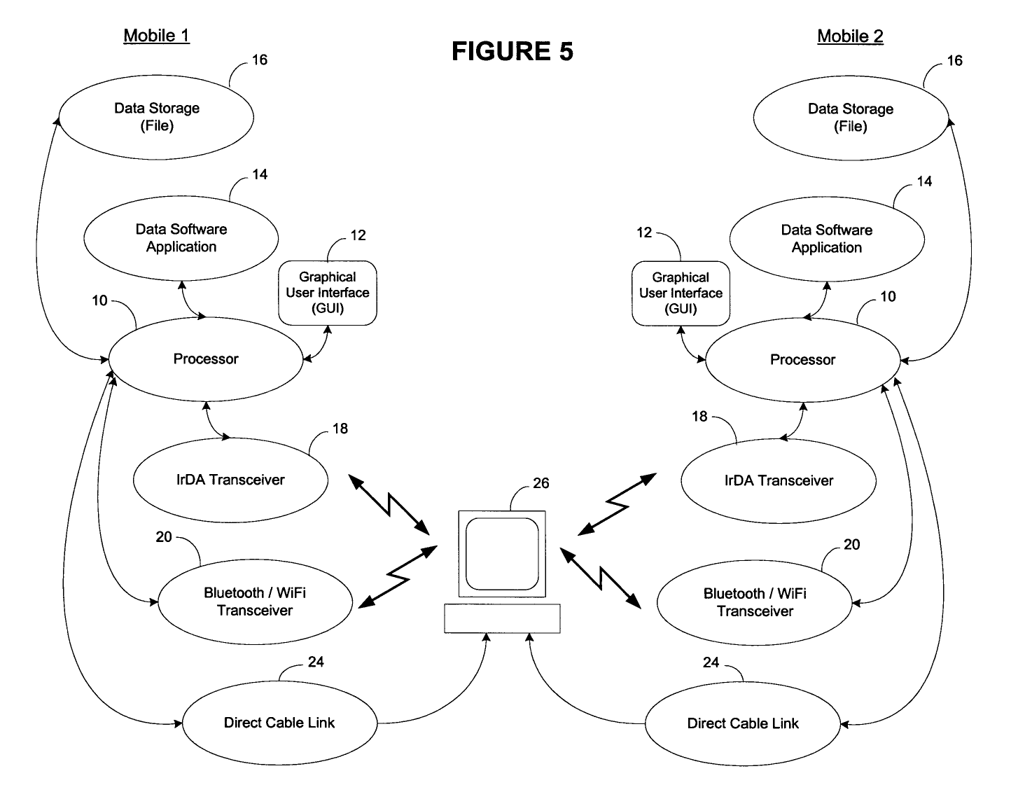

FIG. 5 is a block diagram illustrating functions within a mobile phone used to carry out an indirect transfer of a data file between two mobile phones using a personal computer (PC) as an intermediary. The description of FIG. 5 is identical to that of FIG. 1 for elements that match. In FIG. 5, however, a direct cable link 24 and personal computer (PC) 26 has been included. The process of transferring a data file 16 from a sending mobile phone to a receiving mobile phone uses the PC 26 as an intermediary.

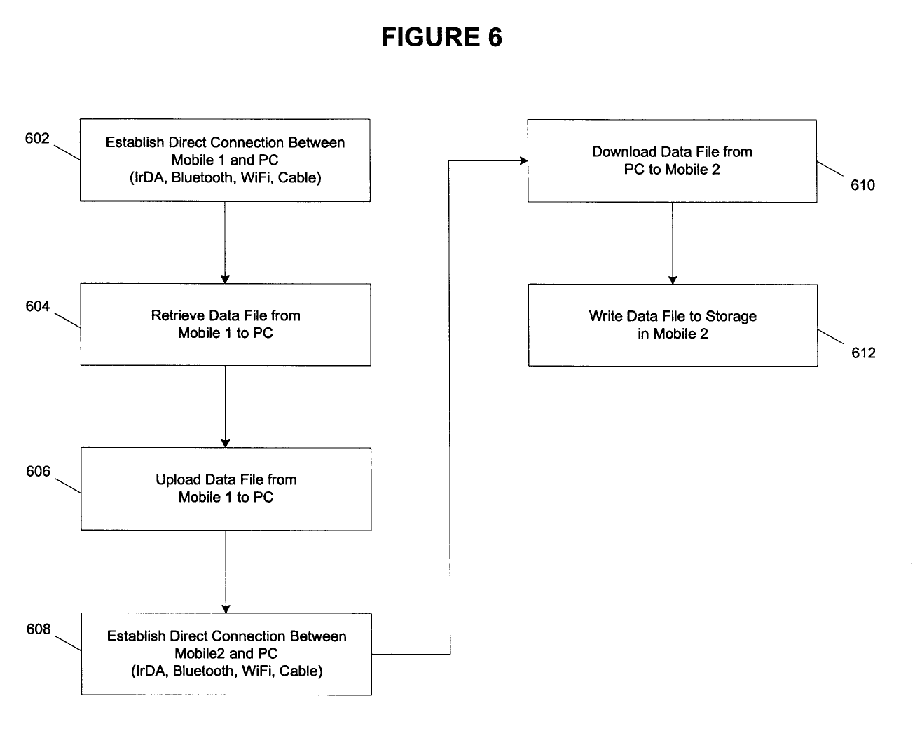

FIG. 6 is a flowchart describing an indirect transfer of a data file between two mobile phones using a personal computer (PC) as an intermediary. The first step is to have the sending mobile phone establish a direct connection 602 with the PC 26. This connection can be established using any one of the connection mechanisms shown (IrDA 18, Bluetooth™ or WiFi 20, or direct cable 24). Once the connection is established 602, the user is prompted by the sending mobile phone via GUI 12 to read the data file 16 from internal memory 604 and transfer or upload 606 the data file 16 to the PC 26.

To transfer the data file 16 to a receiving mobile phone, the PC 26 establishes a direct connection 608 to the receiving mobile phone just as described above. Once the connection is established 608, the user is prompted by the receiving mobile phone via GUI 12 to retrieve or download 610 the data file 16 from the PC 26. The downloaded data file 16 is then written 612 to internal memory on the receiving mobile phone where it can be accessed and used by other applications executing on the mobile phone.

The preceding describes a scenario where the intermediary PC 26 is the same for the sending an receiving mobile phone. This does not necessarily have to be the case. It is quite possible and even probable that a different PC 26 will be used for uploading from the sending mobile phone and downloading to the receiving mobile phone. In this scenario, it is necessary to transfer the data file from one PC to another PC. This is a relatively simple operation that can be carried out via e-mail, over the Internet using a file transfer protocol (ftp), a dedicated connection between two PCs, or some other communication means. The e-mail or Internet scenario seems particularly plausible if the data file is to be transferred between mobile phones that are located apart from one another.

Moreover, while the intermediary device has been described as a PC, it can be any remote processing device that has the ability to communicate with a mobile phone and store a data file. One example is a personal digital assistant (PDA).

In addition, most newer mobile phones include built-in data transferring applications that allow the mobile phone to send and receive data directly to other mobile phones over the cellular network infrastructure that includes access to the Internet. Mobile phones can send and receive data directly to other mobile phones using SMS text messaging services or MMS messaging services, or to Internet e-mail addresses. Thus, an alternative embodiment (not pictured) involves the sending mobile phone including the data file as an attachment in an SMS, MMS, or e-mail message to the receiving mobile phone.

The description above has focused on the exchange of a data file between mobile phones. Types of data files that can be exchanged between mobile phones using the teachings of the present invention include, but are not limited to, bookmark files and mobile phone setting files. Bookmark files can be packaged into a data file and transferred between mobile phones using the methods described above. This would allow one mobile phone user to copy some or all of the bookmarks used by another mobile phone user. This has the beneficial effect of relieving a mobile phone user from having to tediously key in strings of data corresponding to web-sites of interest.

Mobile phone settings can also be packaged into a data file and transferred between mobile phones using the methods described above. This would allow one mobile phone user to adopt some or all of the mobile phone settings used by another mobile phone user. This has the same beneficial effect of relieving a mobile phone user from having to tediously key in data settings such as WAP, e-mail, picture sharing, settings, etc.

The present invention can also be used to archive mobile phone settings or bookmarks on a personal computer. This would allow the mobile phone user to recover data should the mobile phone become corrupted.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. A mobile phone having a software application for wirelessly sending a data file resident in the mobile phone to a second mobile phone, said mobile phone comprising:
a processor;
a processor readable storage medium;
code recorded in the processor readable storage medium to establish a connection with the second mobile phone such that data can be exchanged between the mobile phone and the second mobile phone;
code recorded in the processor readable storage medium to retrieve the data file; and
code recorded in the processor readable storage medium to send the data file to the second mobile phone via the connection established between the mobile phone and the second mobile phone.

2. The mobile phone of claim 1 wherein the connection established between the mobile phone and the second mobile phone is an RF connection.

3. The mobile phone of claim 1 wherein the connection established between the mobile phone and the second mobile phone is a Bluetooth™ connection.

4. The mobile phone of claim 1 wherein the connection established between the mobile phone and the second mobile phone is a WiFi connection.

5. The mobile phone of claim 1 wherein the connection established between the mobile phone and the second mobile phone is an IrDA connection.

6. The mobile phone of claim 1 wherein the data file is a bookmark file.

7. The mobile phone of claim 1 wherein the data file is a mobile phone settings file.

8. A mobile phone having a software application for receiving a data file from a second mobile phone, said mobile phone comprising:
a processor;
a processor readable storage medium;
code recorded in the processor readable storage medium to establish a connection with the second mobile phone such that data can be exchanged between the mobile phone and the second mobile phone;
code recorded in the processor readable storage medium to receive the data file sent from the second mobile phone via the connection established between the mobile phone and the second mobile phone; and
code recorded in the processor readable storage medium to write the data file to storage in the mobile phone.

9. The mobile phone of claim 8 wherein the connection established between the mobile phone and the second mobile phone is an RF connection.

10. The mobile phone of claim 8 wherein the connection established between the mobile phone and the second mobile phone is a Bluetooth™ connection.

11. The mobile phone of claim 8 wherein the connection established between the mobile phone and the second mobile phone is a WiFi connection.

12. The mobile phone of claim 8 wherein the connection established between the mobile phone and the second mobile phone is an IrDA connection.

13. The mobile phone of claim 8 wherein the data file is a bookmark file.

14. The mobile phone of claim 8 wherein the data file is a mobile phone settings file.

15. A mobile phone having a software application for copying a data file resident in the mobile phone to a removable storage medium that is usable with the mobile phone, said mobile phone comprising:
a processor;
a processor readable storage medium;
code recorded in the processor readable storage medium to retrieve the data file; and
code recorded in the processor readable storage medium to write a copy of the data file to the removable storage medium.

16. The mobile phone of claim 15 wherein the removable storage medium is a memory stick.

17. The mobile phone of claim 15 wherein the removable storage medium is a SIM card.

18. The mobile phone of claim 15 wherein the removable storage medium is a compact flash card.

19. The mobile phone of claim 15 wherein the data file is a bookmark file.

20. The mobile phone of claim 15 wherein the data file is a mobile phone settings file.

21. A mobile phone having a software application for copying a data file from a removable storage medium that is usable with the mobile phone to the mobile phone, said mobile phone comprising:
a processor;
a processor readable storage medium;
code recorded in the processor readable storage medium to retrieve the data file from the removable storage medium; and
code recorded in the processor readable storage medium to write a copy of the data file to the mobile phone.

22. The mobile phone of claim 21 wherein the removable storage medium is a memory stick.

23. The mobile phone of claim 21 wherein the removable storage medium is a SIM card.

24. The mobile phone of claim 21 wherein the removable storage medium is a compact flash card.

25. The mobile phone of claim 21 wherein the data file is a bookmark file.

26. The mobile phone of claim 21 wherein the data file is a mobile phone settings file.

27. A mobile phone having a software application for sending a data file from the mobile phone to a remote processing device, said mobile phone comprising:
a processor;
a processor readable storage medium;
code recorded in the processor readable storage medium to establish a connection with the remote processing device such that data can be exchanged between the mobile phone and the remote processing device;
code recorded in the processor readable storage medium to retrieve the data file; and
code recorded in the processor readable storage medium to send the data file to the remote processing device via the connection established between the mobile phone and the remote processing device.

28. The mobile phone of claim 27 wherein the connection established between the mobile phone and the second mobile phone is an RF connection.

29. The mobile phone of claim 27 wherein the connection established between the mobile phone and the second mobile phone is a Bluetooth™ connection.

30. The mobile phone of claim 27 wherein the connection established between the mobile phone and the second mobile phone is a WiFi connection.

31. The mobile phone of claim 27 wherein the connection established between the mobile phone and the second mobile phone is an IrDA connection.

32. The mobile phone of claim 27 wherein the connection established between the mobile phone and the second mobile phone is a cable.

33. The mobile phone of claim 27 wherein the data file is a bookmark file.

34. The mobile phone of claim 27 wherein the data file is a mobile phone settings file.

35. A mobile phone having a software application for receiving a data file from a remote processing device, said mobile phone comprising:
a processor;
a processor readable storage medium;
code recorded in the processor readable storage medium to establish a connection with the remote processing device such that data can be exchanged between the mobile phone and the remote processing device;
code recorded in the processor readable storage medium to receive the data file from the remote processing device via the connection established between the mobile phone and the remote processing device; and
code recorded in the processor readable storage medium to write the data file to storage in the mobile phone.

36. The mobile phone of claim 35 wherein the connection established between the mobile phone and the second mobile phone is an RF connection.

37. The mobile phone of claim 35 wherein the connection established between the mobile phone and the second mobile phone is a Bluetooth™ connection.

38. The mobile phone of claim 35 wherein the connection established between the mobile phone and the second mobile phone is a WiFi connection.

39. The mobile phone of claim 35 wherein the connection established between the mobile phone and the second mobile phone is an IrDA connection.

40. The mobile phone of claim 35 wherein the connection established between the mobile phone and the second mobile phone is a cable.

41. The mobile phone of claim 35 wherein the data file is a bookmark file.

42. The mobile phone of claim 35 wherein the data file is a mobile phone settings file.
